(19) United States
(12) Patent Application Publication
(10) Pub. No.: US 2022/0046176 A1
(43) Pub. Date: Feb. 10, 2022

(54) Automatic Instructor Tracking and Camera Zoom and Tilt for Clear Blackboard/Whiteboard Writing Capture.

(71) Applicant: Prasad Narasimha Seshadri, Las Vegas, NV (US)

(72) Inventor: Prasad Narasimha Seshadri, Las Vegas, NV (US)

(21) Appl. No.: 17/362,077

(22) Filed: Jun. 29, 2021

Related U.S. Application Data
(60) Provisional application No. 63/103,399, filed on Aug. 5, 2020.

(51) Int. Cl. H04N 5/232; H04L 29/06

(52) U.S. Cl. CPC H04N 5/23299; H04N 5/23296; H04N 5/23206; H04N 5/23218; H04N 5/232127; H04L 65/4015

(57) ABSTRACT

A method and system for automating the camera movement and to zoom in on the latest instructor writing by properly centering the latest writing in the camera view and zooming in to achieve good magnification as well as focus—enabling the writing to be seen clearly without requiring a greater than 100% zoom on the browser being used by the viewer either on a laptop, desktop, or a mobile device.

### CORRESPONDING RELATED APPLICATIONS

The present invention claims the benefit of U.S. Non-Provisional patent application Ser. No. 12/125,395 by Prasad Seshadri, filed on May 22, 2008 and entitled “Method and apparatus for effectively capturing and broadcasting a traditionally delivered classroom or a presentation” and granted on Jun. 13, 2014. The present application claims the benefit of and priority to this non-provisional application, the entire contents of which are incorporated by reference herein in its entirety. Reference is also hereby made to U.S. patent application Ser. No. 11/171,825 by Prasad Seshadri, filed on Jun. 29, 2005, entitled “Method and apparatus for effectively capturing a traditionally delivered classroom or a presentation and making it available for review over the Internet using remote production control” and incorporated by reference herein in its entirety.

### BACKGROUND

### Field of the Invention

Instruction/Presentational content generated by university personnel as well as organizational wisdom created by professionals in organizations are either being lost to posterity or not being harnessed to their full potential, since the content disappears and is preserved imperfectly only in the minds of a few. One of the greatest challenges in introducing technology into classroom or a presentation context is resistance to technology on the part of a traditional Instructor/Presenter, who must focus on Instruction/Presentation and the students/audience rather than be distracted by presentation technology issues, which do not represent his/her core interest or objective, and is therefore unwilling to make the adjustments or compromises necessary to adapt to technology.

### BRIEF DESCRIPTION OF THE DRAWINGS

FIG. 1: Illustrates how blackboard-based writings appear without camera zoom.

FIG. 2: Illustrates how blackboard-based writing appears magnified because of only camera zoom but no tilt to center the writing to the camera field of view.

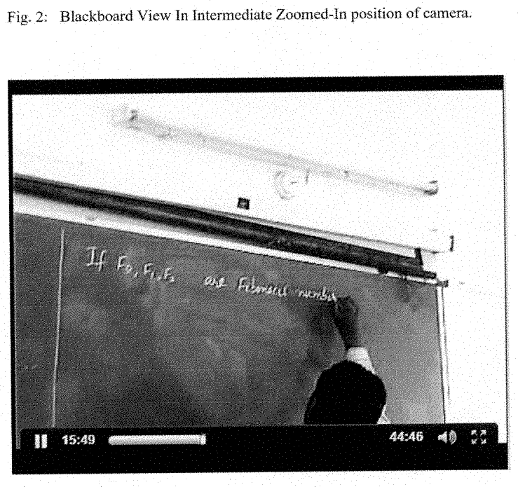

FIG. 3: Illustrates how the blackboard-based writing appears both magnified and centered when the camera is tilted to center the writing to the camera field of view.

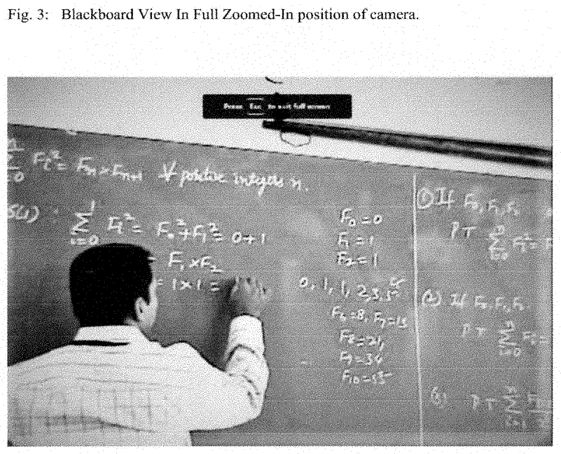

### SUMMARY

The following changes have been implemented to the system described in Ser. No. 12/125,395.

Major disadvantages of the system described in Ser. No. 12/125,395 are as follows:
a) The requirement of a person to control the camera even though the system attempts To make it extremely easy to do so by employing a User Interface with which the cameras can be selected and controlled without fatigue and distraction by mouse clicks for PAN and TILT and the roller for ZOOM functions.
b) The requirement of the instructor to wear any RFID or similar emitters to help achieve automation of camera movement to eliminate the disadvantage posed by requirement to move the cameras manually, is awkward and not practical.

The described methodology aims to eliminate the two disadvantages by developing a Robot that simulates a person manually controlling the camera via a user interface by means of mouse or touchpad clicks and roller action or touchpad action for ZOOM.

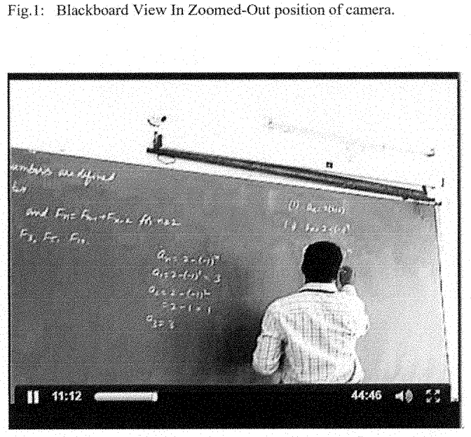

Artificial intelligence is used to move the instructor camera so that the instructor is always centered in the camera view by simulating clicks in the vertical center of the camera view and clicking towards the right or the left of the vertical center to PAN the camera to keep the instructor centered. This program runs on the computer labeled 16 in FIG. 1 of Ser. No. 12/125,395.

In one embodiment of the AI software, the instructor is assumed to be right-handed and every now and then, when the instructor stops, it is assumed that the instructor has stopped to write and the AI software simulated the ZOOM IN function of a mouse or touchpad

The ZOOM in factor described in [0005] is programmable so that any blackboard/whiteboard/green board writing is magnified, and the camera can focus on it and is clearly visible.

However, automating only the PAN and ZOOM still does not center the latest writing In the camera view if the writing is towards the top of the writing surface or the bottom of the writing surface.

In the zoomed in position, the program further analyzes the degree by which the latest writing is off-center in the vertical direction.

The camera is tilted upward or downward depending on the degree and direction of the Off-center.

This brings the writing closer to the center of the view.

This will enable a further optical zoom in to be applied to the instructor camera so that a greater magnification of the writing is achieved, and the writing can be seen very clearly without having to require a digital zoom on the browser or to have to put the video on full-screen mode.

Another embodiment of the software that achieves all the functions above for left-handed instructors.

Automation of camera movement means there is no one to monitor if the microphone is working. Therefore, following steps are taken to minimize the microphone related problems. Two long corded lapel microphones are provided—one acting as a spare. Wired microphone eliminates the requirement to assign different frequency channels to adjoining or nearby classrooms. The microphone goes directly into the microphone input of the desktop computer. The encoder desktop software enables the input audio to be routed back to the headphone output for monitoring. This output is sent to a mixer for amplification. An external speaker is connected to the speaker output of the mixer. This enables the instructor to hear his/her own voice thereby enabling him/her to know that the audio is functioning properly.

I claim:

1. A system for detecting the latest writing on a blackboard/whiteboard/green board or similar writing surface by employing artificial intelligence.

2. Automatically tracking the instructor via motion detection feature of the AI program, approximately estimating the writing area.

3. Intermediate Zooming in without vertical offset, to determine the direction and degree of vertical offset needed to center the latest writing. This is illustrated in the FIG. PAN-P005-2.

4. Achieving upward or downward tilt necessary to center the latest writing in the instructor camera view.

5. Further optical ZOOM in of the instructor camera to magnify the latest writing to further improve the clarity as well as the focus of the latest writing. This is illustrated in FIG. PAN-P005-3.

6. Another embodiment of the software that enable directly going from approximate estimate of the latest writing to achieve both zoom and tilt in a single step without going through an intermediate step.

7. Another embodiment of the software that automatically estimates the left or right handedness of the instructor and performs all the functions described above.

8. Another embodiment of the software that drives the instructor camera using the IP address of the camera and its native API to drive the camera motion after receiving the visual data from the camera instead of simulating mouse or touchpad activity on the User Interface.

9. Another embodiment that drives the instructor camera using hand detection features of artificial intelligence to derive information on the position of instructor writing.
